(19) United States
(12) Patent Application Publication
(10) Pub. No.: US 2010/0318346 A1
(43) Pub. Date: Dec. 16, 2010

(54) SECOND LANGUAGE PRONUNCIATION AND SPELLING

(76) Inventor: Marc Miyake, Burlington, NJ (US)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 12/485,417

(22) Filed: Jun. 16, 2009

(51) Int. Cl. G10L 15/00

(52) U.S. Cl. 704/7; 704/E15.003

(57) ABSTRACT

The invention has as its objective to aid an individual proficient in a first language in learning the pronunciation and spelling of a second language. To achieve this objective, a language teaching device comprises a processor, a memory, a presentation screen, an audio component and an input unit. The memory has a database, audio files and games. The database is structured to have at least three subsets. The first subset lists spelling patterns in the first and second languages which have similar pronunciations and words in the second language which exemplify the pronunciation. A second subset lists spelling patterns and words in the second language exemplifying a pronunciation not found in the first language, the listed spelling patterns and associated pronunciation in the second subset follow a general rule of pronunciation in the second language. A third subset lists spelling patterns and words exemplifying a spelling pattern and associated pronunciation occurring in fewer than a predetermined number of words in the second language set of words.

### BACKGROUND OF THE INVENTION

This invention relates to an apparatus and method to aid an individual proficient in a first language in learning a second language.

One aspect of how languages differ that make learning a second language difficult include the fact that the spelling of the same audible sound, often called a phoneme, differs in the two languages. Another difference is that the second language (that is, the language to be learned) will have audible sounds that do not exist in the first language. Some of these audible sounds that appear in the second language, but not in the first language, will follow a spelling rule in the second language. Others will not but will have a unique spelling. To throw the student off further, there are words where two or more spellings in the second language are used for the same audible sound.

An object of this invention is an apparatus and technique that will permit a student to learn a second language with procedures selected by the student at a pace selected by the student.

A further object is to provide the above including both spelling and audible pronunciation.

A further object is to provide these objects in a readably useable form that is easy to use and thus encourage the student's use of the device and its technique.

### BRIEF DESCRIPTION

One embodiment of this invention is for the purpose of aiding an individual proficient in a first language (Chinese) to learn the pronunciation and spelling of a second language (English). A language teaching apparatus with an electronic memory has a database containing a set of language spelling patterns from both languages and a set of words from the second language. The database provides at least three subsets of data.

Each member of a first subset is (a) a spelling pattern in the second language, (b) at least one word from the set of second language words exemplifying the pronunciation of an associated spelling patterns, and (c) a spelling pattern from the first language that has a pronunciation similar to the pronunciation in the second language.

Each member of a second subset is a spelling pattern and at least one word from the set of second language words exemplifying the spelling pattern pronunciation in the second language that is not found in the first language. Each spelling pattern member of this second subset has a pronunciation determined by a general usage rule of pronunciation in the second language.

Each member of a third subset is a spelling pattern and at least one word from the set of second language words exemplifying the spelling pattern pronunciation in said second language. In this third subset the spelling pattern and associated pronunciation occurs in fewer that a predetermined number of words in the set of second language words.

The third subset includes a group of exceptional words having a pronunciation and spelling unique for those words in the set of words in said second language.

The device may contain a fourth subset of second language words, each of the words in the fourth subset being tagged with codes representing the spelling patterns in said word.

a presentation screen coupled to the memory displays selected members of the three subsets including spelling patterns and associated words. An audio file contains the pronunciation of words in the set of second language words, and a speaker coupled to the audio file provides audible pronunciation of words displayed on the presentation screen. The audio function is turned on or off by the student using the device.

An electronic game provides a game exercise on the presentation screen to make possible, at the student's option, playing a game using the members of the subset concurrently displayed on the screen. The game is turned on or off by the student.

The method of using the device disclosed is also described herein.

### DEFINITIONS

Spelling Patterns are one or more letters within a word which form a particular pronunciation. A spelling pattern represented by a single letter or a number of consecutive letters.

Pronunciation is how a spelling pattern sounds within the context of a word. It is usually, but not necessarily, a generally recognized phoneme.

### BRIEF DESCRIPTION OF THE FIGURES

All FIGs. relate to a single embodiment involving Chinese as a first language and English as a second language.

FIG. 1 is a block diagram showing the relationship between major components that are used in the practice of this embodiment.

FIG. 2 is a chart depicting subset 1 of the database representing spelling patterns which are pronounced the same in English and Chinese as employed in the present invention.

FIG. 3 is a continuation of the chart in FIG. 2 depicting subset 1 of the database.

FIG. 4 is a chart depicting subset 2 of the database representing numerous spelling patterns which have no corresponding pronunciation in Chinese and in which an English language rule is applied to the pronunciation of the spelling patterns shown as employed in the present invention.

FIG. 5 is a chart depicting subset 3 of the database representing exceptional spelling patterns and exceptional words in English having a pronunciation and a spelling that is unique.

FIG. 6 is a chart showing a listing of words tagged with corresponding spelling patterns.

FIG. 7 is a flow diagram showing the steps of the method implemented on the apparatus of the present invention.

FIG. 8 is a continuation of the flow diagram in FIG. 7.

### DETAILED DESCRIPTION

The present invention relates to an apparatus and method to aid individuals proficient in a first language in learning a second language.

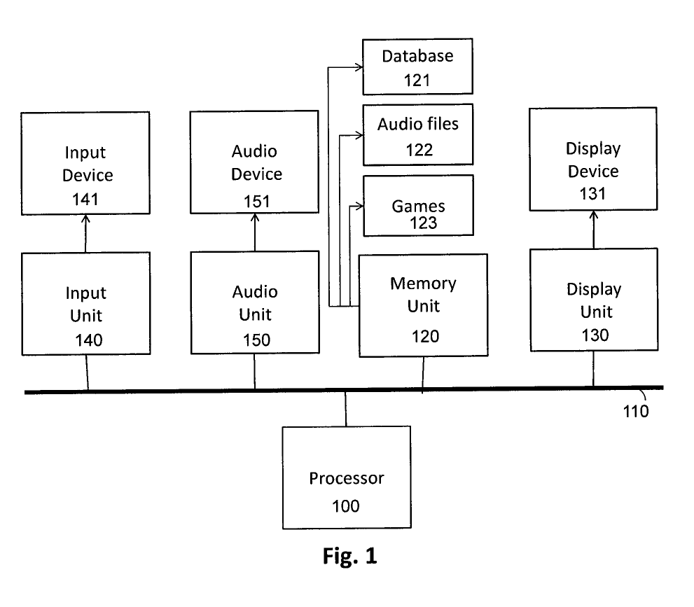

FIG. 1 of the accompanying drawings is a block diagram of the major components of the apparatus which implements the method of the present invention. The method of the present invention may be implemented on a variety of devices containing these components including portable hand held devices, cellular phones, laptop computers and desktop computers.

As shown, the apparatus includes a processor 100 interfacing via a system bus 110 with at least a memory unit 120, a display driver unit 130, an input driver unit 140 and audio driver unit 150. The display driver unit 130 drives any of a variety of display devices 131 including an LCD screen, a touch screen interface display and a stand-alone monitor. The display device 131 provides the apparatus a means to display information and query a user for input.

The input driver unit 140 drives any of a variety of input devices 141 including a keyboard, a mouse and a touch screen interface. The input device 141 provides the user a means of inputting information to the apparatus.

The audio driver unit 150 drives a variety of output audio devices 151 including speakers and headphones. The output audio device 151 provides the apparatus a means of outputting audio based on stored audio files.

The memory unit 120 provides the apparatus with volatile and non-volatile memory to store an operating system and multiple device drivers necessary to the operation of the apparatus. The memory unit 120 also provides the storage and access to the software application employed in the method of the present invention. Further, the apparatus also includes a database 121, audio files 122 and games 123.

The database 121 is a compilation of information representative of how a first language compares with a second language. The information in the database is structured to provide information in a context which effectively aids a user familiar with a first language to learn a second language. Information retrieved from one subset of the database may be presented to the user in a context and with accompanying instructional data that is different than the context and accompanying instructional provided for information retrieved from a different subset.

The structure of the database includes a subset 1 representing second language (English) spelling patterns with first language (Chinese) pronunciation equivalents, a subset 2 representing repeatedly encountered second language (English) spelling patterns without first language (Chinese) pronunciation equivalents, a subset 3 representing exceptional spellings and a subset 4 representing exemplary words containing multiple second language (English) spelling patterns.

In this embodiment of the present invention, references to the Chinese language are meant to refer to the Pin Yin phonetic version of Mandarin. While this embodiment of the present invention refers to Chinese as the first language and English as the second language, the present invention applies to any two languages.

Records in the database are tagged in a conventional manner to identify from which subset of the database a spelling pattern has been retrieved.

Each of the subsets of the database will be discussed and a representative members described.

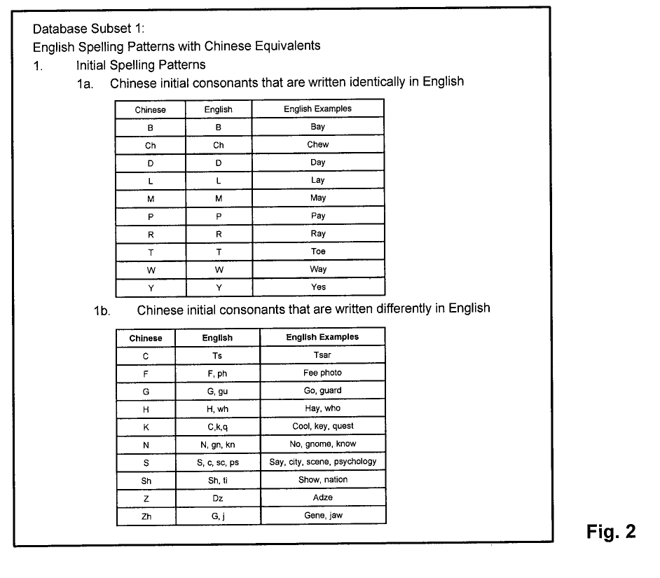

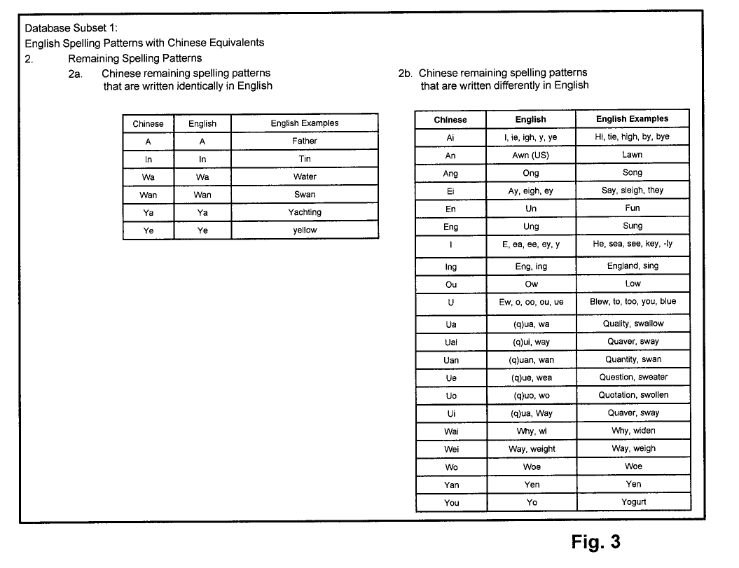

FIGS. 2 and 3 are charts depicting subset 1 of the database. The listings in subset 1 of the database are representative of second language (English) spelling patterns which have an equivalent pronunciation in a first language (Chinese) spelling pattern. Subset 1 is itself divided into a first part (1) listing initial spelling patterns and a second part (2) listing remaining spelling patterns.

As shown in FIG. 2, the listing of initial spelling patterns in the first part (1) of subset 1 is further divided into a first subpart (1a) listing first language (Chinese) initial spelling patterns that are written identically in the second language (English) and a second subpart (1b) listing first language (Chinese) initial spelling patterns that are written differently in the second language (English).

Therefore, the first subpart (1a) of the initial spelling patterns part of subset 1 provides a listing is of those spelling patterns in the first language (Chinese) whose pronunciation is provided in the second language (English) by an identical spelling pattern.

As an example, a database record containing the Chinese spelling pattern “b” is linked to a database record containing the English spelling pattern “b,” which has the same pronunciation and is the same spelling pattern as the Chinese spelling pattern “b.”

Furthermore, each second language (English) spelling pattern is linked to a database record containing a word which demonstrates a particular pronunciation of that second language (English) spelling pattern. Moreover, the database record containing this word is also linked to a database record containing a link to an audio file recoding of that word.

In our previous example, the English spelling pattern “b” is linked to a database record containing the word “bay” which demonstrates a pronunciation of the English spelling pattern “b” that is similar to the pronunciation of the Chinese spelling pattern “b.” The database record containing the word “bay” is also linked to a database record containing a link to an audio file recording of the word “bay.”

In the second subpart (1b) of the initial spelling patterns part of subset 1, a listing is provided of those spelling patterns in the first language (Chinese) whose pronunciation is provided in the second language (English) by spelling patterns that are different.

As an example, a database record containing the Chinese spelling pattern “f” is linked to dataset records containing the English spelling patterns “f” and “ph,” both of which have the same pronunciation as the Chinese spelling pattern “f” but which also include an English spelling pattern that is different than the Chinese spelling pattern “f.”

Furthermore, each of database records containing the English spelling pattern “f” and “ph” are linked to database records containing the words “fee” and “photo,” respectively. Each of these words demonstrates a pronunciation of its respective English spelling pattern that is similar to the Chinese spelling pattern “f.” The database records containing the words “fee” and “photo” are also linked to database records containing links to audio file recordings of the words “fee” and “photo.”

As shown in FIG. 3, the second part (2) of subset 1 listing remaining spelling patterns is further divided into a first (2a) and second (2b) subpart in the same manner as the first part of subset 1 listing initial spelling patterns. Specifically, the first subpart (2a) of the second part of subset 1 is a listing of the first language (Chinese) remaining spelling patterns that are written identically in the second language (English) and the second subpart (2b) of the second part of subset 1 is a listing of remaining spelling patterns that are written differently in the second language (English).

As an example, in the first subpart (2a) of the second part of subset 1 listing remaining spelling patterns, a database record containing the Chinese spelling pattern “a” is linked database record containing the English spelling pattern “a,” which has the same pronunciation and is the same spelling pattern as the Chinese spelling pattern “a.”

Furthermore, the database record containing the English spelling pattern “a” is linked to a database record containing the word “father” which demonstrates a pronunciation of the English spelling pattern “a” that is similar to the pronunciation of the Chinese spelling pattern “a.” The database record containing the word “father” is also linked to a database record containing a link to an audio file recording of the word “father.”

As another example, in the second subpart (2b) of the second part of subset 1 listing remaining spelling patterns, a database record containing the Chinese spelling pattern “ai” is linked to database records containing the English spelling patterns “i”, “ie”, “igh”, “y”, and “ye”, all of which have the same pronunciation but are different spelling patterns than the Chinese spelling pattern “f.”

Furthermore, each of the database records containing the English spelling patterns “i”, “ie”, “igh”, “y”, and “ye” are linked to database records containing the words “hi”, “tie”, “high”, “by” and “bye,” respectively, each word demonstrating a pronunciation of its respective English spelling patterns that is similar to the Chinese spelling pattern “ai.” The database records containing the words “hi”, “tie”, “high”, “by” and “bye” are also linked to database records containing links to audio file rewordings of the words “hi”, “tie”, “high”, “by” and “bye.”

As discussed above, spelling patterns from a second language (English) that the user is unfamiliar with are categorized under subset 1 of the database are identified with a spelling pattern from a first language (Chinese) that the user is familiar with where both spelling pattern have similar pronunciations.

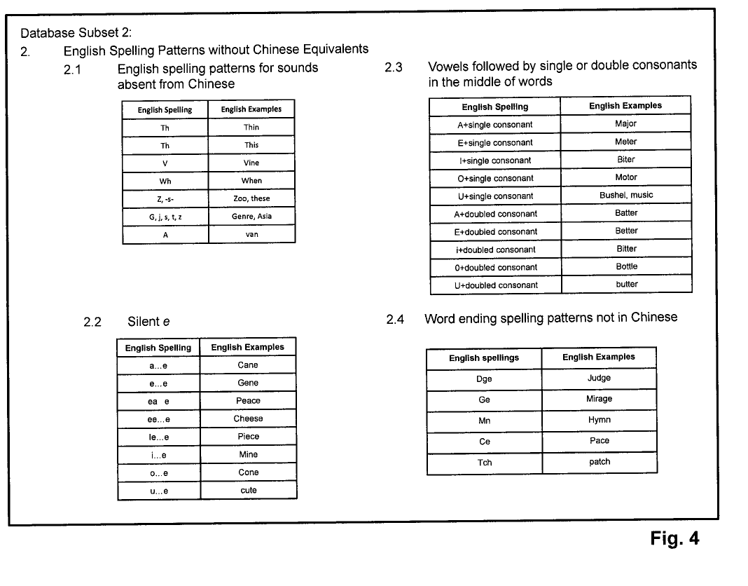

FIG. 4 is a chart depicting subset 2 of the database. The listings in subset 2 are representative of second language (English) spelling patterns having no corresponding pronunciation in the first language (Chinese). Subset 2 is directed to such second language words that illustrate a general usage in the second language. Subset 2 is divided into four parts

As shown in FIG. 4, the first part (2.1) of subset 2 is a listing of second language (English) spelling patterns, each of which, with an associated pronunciation occurs frequently in the second language (English). Like all of the spelling patterns in subset 2 there is no first language similar pronunciation.

As an example, in this part (2.1), a database record containing the English spelling pattern “th” is linked to a database record containing the word “thin” which demonstrates one frequent pronunciation of the English spelling pattern “th”. The database record containing the word “thin” is also linked to database record containing a link to an audio file recording of the word “thin.” Similarly, a second “th” is linked to the word “this” to demonstrate a second frequent pronunciation of “th” in the second language.

As shown in FIG. 4, the second part (2.2) of subset 2 of the database is a listing of second language (English) spelling patterns containing a silent e and which have a pronunciation without an equivalent in the first language (Chinese). As an example, in this part (2.2), a database record containing the English spelling pattern “a . . . e” is linked to a database record containing the word “cane” which demonstrates a pronunciation of the English spelling pattern “a . . . e” having no similar pronunciation in the Chinese language. The database record containing the word “cane” is also linked to database record containing a link to an audio file recording of the word “cane.”

As shown in FIG. 4, the third part (2.3) of subset 2 of the database is a listing of second language (English) vowels followed by single or double consonants in the middle of the word and which have a pronunciation without an equivalent in the first language (Chinese). As an example, in this part (2.3), a database record containing the English spelling pattern “a+ single consonant” is linked to a database record containing the word “major” which demonstrates a pronunciation of the English spelling pattern “a+ single consonant” having no similar pronunciation in the Chinese language. The database record containing the word “major” is also linked to database record containing a link to an audio file recording of the word “major.”

Lastly, as shown in FIG. 4, the fourth part (2.4) of subset 2 of the database is a listing of second language (English) complex spellings of word ending spelling patterns having pronunciations without an equivalent in the first language (Chinese). As an example, in this part 2.4), a database record containing the English spelling pattern “dge” is linked to a database record containing the word “judge” which demonstrates a pronunciation of the English spelling pattern “dge” having no similar pronunciation in the Chinese language. The database record containing the word “judge” is also linked to database record containing a link to an audio file recording of the word “judge.”

The second language (English) spelling patterns categorized under subset 2 of the database have a pronunciation that does not occur in the first language (Chinese). But subset 2 is based on second language spelling patterns having pronunciations that that are seen repeatedly in the second language (English) language. Learning the association between these frequently occurring spelling patterns and associated pronunciations is thus particularly useful to the student.

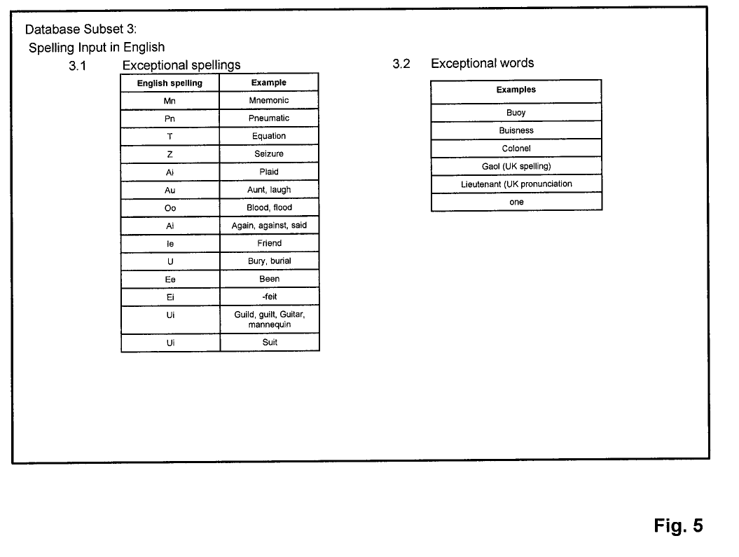

FIG. 5 is a chart depicting subset 3 of the database. Like subset 2, subset 3 is directed to second language pronunciations which have no equivalent in the first Language. Subset 3 is divided into a first part (3.1) which lists exception spellings and a second part (3.2) which lists exceptional words. As an example, in the first part (3.1), a database record containing the English spelling pattern “mn” is linked to a database record containing the word “mnemonic” which demonstrates a pronunciation of the English spelling pattern “mn” which is not seen with regularity in the English language and has no similar pronunciation in Chinese. Also, in the second part (3.2), a database record contains the English word “buoy” whose spelling and particular pronunciation is not seen with regularity in the English language.

The regularity with which a spelling pattern and associated pronunciation or a word and associated pronunciation occurs so as to be placed in subset 3 of the database is a predetermined number which, through experience, is been found to be optimal in aiding the learning of a second language. In the illustrated first part (3. 1) of subset 3, this number has been determined to be four. However, this predetermined number may vary with language and experience.

As can be seen from the above discussion, the second language (English) spelling patterns and words categorized under subset 3 of the database neither have a similar first language (Chinese) pronunciation nor follow a language rule repeatedly seen in the second language (English). These second language (English) spelling patterns and words will most probably be best learned by repeated review and memorization.

Subset 3 also may include second language (English) spelling patterns which could be categorized under subset 2 but whose pronunciation is found in only a few second language (English) words. Since these pronunciations do not occur with regularity, it is best to master those spelling patterns in subset 2 which the user will encounter with greater regularity than those in subset 3.

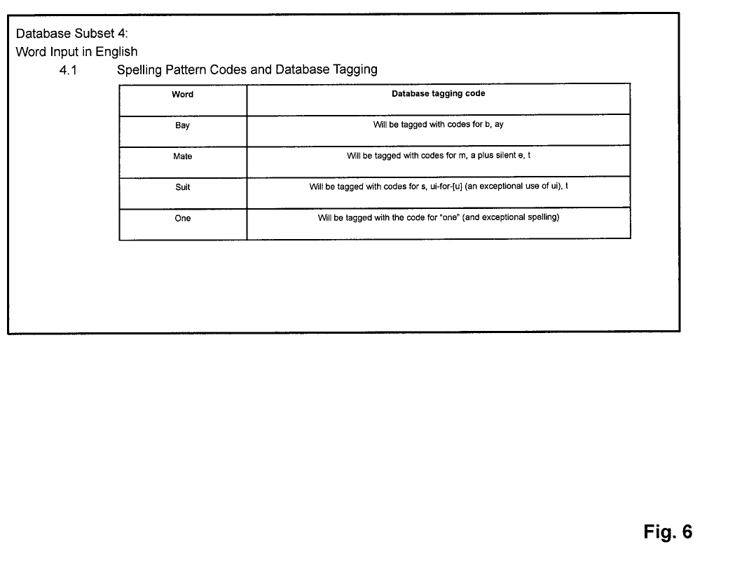

FIG. 6 is a chart depicting subset 4 of the database. The listing in subset 4 is representative of certain words tagged with corresponding spelling patterns. This subset provides for the input of certain words, rather than spelling patterns, each word demonstrates the use of multiple second language (English) spelling patterns.

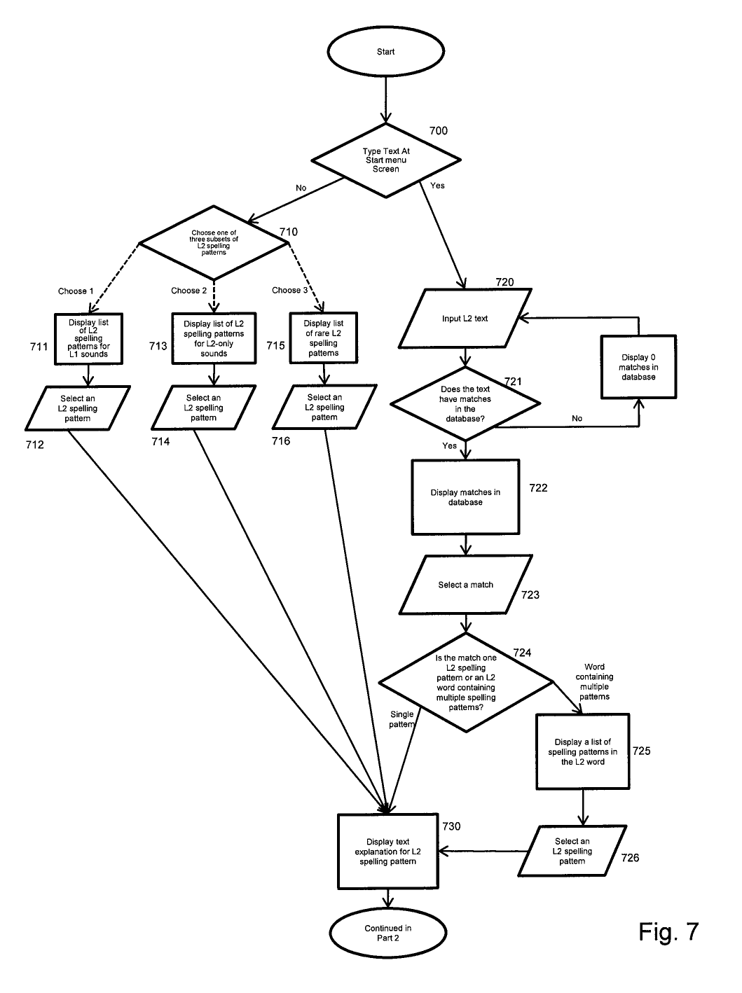

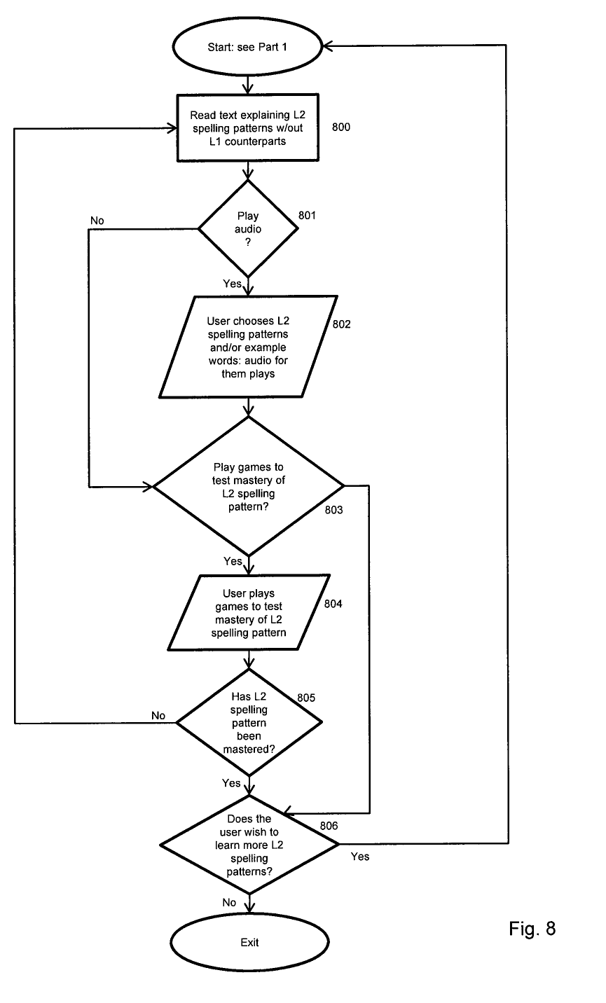

The method implemented on the apparatus of the present invention ands its use of the database and stored audio files, as described above, is illustrated in FIGS. 7 and 8.

FIGS. 7 and 8 are flow diagrams showing the steps of the method implemented on the apparatus of the present invention.

A user initially makes a selection from a start-up screen. The star-up screen includes options to display a listing of spelling patterns from any one of the first three subsets of the database (subset 1, subset 2 and subset 3) or to search the entire database (all four subsets of the database) for a particular spelling pattern or a word.

In FIG. 7, at step 700, the apparatus determines which option has been selected from the start-up screen. If the selected option is to display a listing from a particular subset, the method advances to step 710. Alternatively, if the selected option is to search the entire database for a particular spelling pattern or word, the method advances to step 720.

If the selected option is to display a listing from one of the first three subset of the database, step 810 determines which subset was selected. If subset 1 was selected, the method then advances to step 711 where subset 1's listing of spelling patterns is displayed, then onto step 712 where a specific spelling patterns is selected from the listing and then onto step 730 where specific information correspond to the selected spelling pattern is displayed. The same sequence is performed through steps 713 and 714 if subset 2 is selected and through steps 715 and 716 if subset 3 is selected.

The corresponding information displayed in step 730 will be dependent on the subset of the database that is being displayed. Specifically, a display of a spelling pattern categorized under subset 1 of the database will include the selected second language spelling patters, other second language spelling patterns with a similar particular pronunciation, first language spelling patterns having a similar particular pronunciation, second language words demonstrating the particular pronunciation for each of the displayed second language spelling patterns and links to audio file recordings of each word.

A display of a spelling pattern categorized under subset 2 of the database will include the selected second language spelling patterns, other second language spelling patterns having a similar particular pronunciation, second language words demonstrating the particular pronunciation for each of the displayed spelling patterns and links to audio file recordings of each word. Additionally, information concerning the applicable subset 2 language rule may also be display.

A display of spelling pattern categorized under subset 3 will include the selected spelling pattern, second language words demonstrating a particular pronunciation associated with the selected spelling pattern and a link to an audio file for each word. If the subset 3 selection was an exceptional word, rather than a spelling pattern, then the display will be of the selected word and a link to an audio file for that word.

Alternatively, if the selected option at the start-up screen was to search the entire database for a spelling pattern or a word, in step 720, a spelling pattern or word is entered into a search input screen and, in step 721, the system then searches the entire database for a match. If matches are found, the results are displayed in step 722. If no matches are found, the search input screen is again displayed in step 720 without displaying any results.

If matches are found in response to the search query submitted in step 720, the results are displayed in step 722 and one of the displayed results is selected in step 723.

Since a result from a search query of the entire database could result in either a matching spelling pattern from subsets 1, 2 or 3 of the database or a word from subset 4 of the database, the apparatus, in step 724, must determine whether the result selected in step 723 is a spelling pattern or a word.

If it is determined in step 724 that the selected result is a spelling pattern, then the selected spelling pattern is forwarded to step 730 and displayed as described above.

Alternatively, if the selected result is a word, a listing of spelling patterns associated with the selected word are displayed in step 725 and one of the displayed associated spelling patterns is selected in step 726. The selected associated spelling pattern is then forwarded to step 730 and displayed as described above.

In FIG. 8, in step 800, the information associated with a selected spelling pattern is displayed.

In step 801, the option to play an audio recording of any one of the displayed words demonstrating a particular pronunciation pattern is provided. If a user selects to play an audio recording, the system advances to step 802. If the user selects not to play an audio recording, the system advances to step 803.

In step 802, the selected audio file is retrieved from memory and played through the audio interface of the apparatus. The user can listen to the audio file once or multiple times in order to master the particular pronunciation. Once the user has finished listening to the audio file, the system advances to step 803.

In step 803, the option to play a game to aid in mastering a spelling pattern is provided. If the option to play a game is selected, the system advances to step 804. If the option to play a game is not, the system advances to step 806.

In step 804, a game to aid in mastering a spelling pattern is retrieved from memory and implemented on the system. The game may be a single one that is played for all selected spelling patterns or one that is customized based on which subset of the database the selected spelling pattern has been categorized under.

In step 805, the user is queried has to whether or not he/she has mastered the selected spelling pattern. If the user responds that he has not mastered the selected spelling patter, he/she is returned to step 800 where the information provided in step 730 concerning the selected spelling pattern is again displayed and the option to listen to audio files and play a game is again provided.

Alternatively, if the user responds that they have mastered the selected spelling pattern, the system advances to step 806 where the user is provided the option to exit or to continue learning a different spelling patter.

Certain embodiments of the invention have been described. It should be understood that one skilled in the art can vary certain details without departing form the scope of the invention. The claims are intended to cover all embodiments of the invention.

1. A language teaching device adapted for teaching a person familiar with a first language, the pronunciation and spelling of a second language, comprising:
a memory having a database containing a set of language spelling patterns from both of said languages and a set of words from said second language,
a first subset of said database in which each member of said first subset is (a) a spelling pattern in said second language, (b) at least one word from said set of second language words exemplifying the pronunciation of said spelling patterns, and (c) a spelling pattern from said first language that has a pronunciation similar to said pronunciation in said second language,
a second subset of said database in which each member of said second subset is a spelling pattern and at least one word from said set of second language words having a spelling pattern pronunciation in said second language not found in said first language, and in which each spelling pattern member of said second subset has a pronunciation determined by a general usage rule of pronunciation in said second language,
a third subset of said database in which each member of said third subset is a spelling pattern and at least one word from said set of second language words having a spelling pattern pronunciation in said second language and in which the spelling pattern and associated pronunciation occurs in fewer that a predetermined number of words in said set of second language words,
a presentation screen coupled to said memory for displaying selected members of said three subsets including spelling patterns and associated words,
an audio file containing pronunciation of words in said set of second language words, and
an audio output component coupled to said audio file to provide audible pronunciation of words displayed on said presentation screen.

2. The device of claim 1 wherein: said audio output component is manually initiated.

3. The device of claim 1 further comprising: an electronic game to permit a game exercise on said presentation screen using the members of the subset concurrently displayed on said screen.

4. The device of claim 2 further comprising: an electronic game to permit a game exercise on said presentation screen using the members of the subset concurrently displayed on said screen.

5. The device of claim 3 wherein: said electronic game is manually initiated.

6. The device of claim 4 wherein: said electronic game is manually initiated.

7. The device of claim 1 wherein: said third subset includes a group of exceptional words having a pronunciation and spelling unique for those words in said set of words in said second language.

8. The device of claim 2 wherein: said third subset includes a group of exceptional words having a pronunciation and spelling unique for those words in said set of words in said second language.

9. The device of claim 4 wherein: said third subset includes a group of exceptional words having a pronunciation and spelling unique for those words in said set of words in said second language.

10. The device of claim 7 wherein: said third subset includes a group of exceptional words having a pronunciation and spelling unique for those words in said set of words in said second language.

11. The device of claim 1 further comprising: a forth subset of second language words, each of said words in said fourth subset tagged with codes for each spelling pattern in the word.

12. The device of claim 7 further comprising: a forth subset of second language words, each of said words in said fourth subset tagged with codes for each spelling pattern in the word.

13. The device of claim 10 further comprising: a fourth subset of second language words, each of said words in said fourth subset tagged with codes for each spelling pattern in the word.

14. The method of assisting a student familiar with a first language to learn a second language comprising the steps of:
providing a set of words in memory in said second language,
a first step of displaying on a screen at least one second language word and associated spelling pattern from a first subset of said words, each of which words in said first subset includes the pronunciation of the associated spelling pattern and wherein said pronunciation corresponds to a pronunciation of a first language spelling pattern,
a second step of displaying on a screen at least one second language word and associated spelling pattern from a second subset of said words, each of which words in said second subset includes the pronunciation of the associated spelling pattern and wherein said pronunciation has no correspondence to any first language pronunciation and wherein said spelling pattern pronunciation follows a general usage rule of pronunciation in said second language,
a third step of displaying on a screen at least one second language word and associated spelling pattern from a third subset of said words, each of which words in said third subset includes the pronunciation of the associated spelling pattern and wherein said pronunciation has no correspondence to any first language pronunciation, and wherein the spelling pattern and associated pronunciation occur fewer than a predetermined number of times in the said set of words, and
providing a manually initiated audible pronunciation of the word provided on the screen during said first, second and third steps, and
repeating said first second and third steps for a plurality of said first, second and third sets of words.

15. The method of claim 14 further comprising the step of: playing a game on a screen employing individual words from said first, second and third set of words.

16. The method of claim 14 further comprising the steps of: displaying on a screen at least one second language word tagged with codes for each spelling pattern in the word.
